(19) United States
(12) Patent Application Publication
(10) Pub. No.: US 2018/0251218 A1
(43) Pub. Date: Sep. 6, 2018

(54) Space Combat Drone

(71) Applicant: Christopher Wilkinson, Brooklyn, NY (US)

(72) Inventor: Christopher Wilkinson, Brooklyn, NY (US)

(21) Appl. No.: 15/760,259

(22) PCT Filed: Sep. 16, 2016
(86) PCT No.: PCT/US16/52091

§ 371 Date: Mar. 15, 2018

Related U.S. Application Data
(60) Provisional application No. 62/219,239, filed on Sep. 16, 2015.

(51) Int. Cl. B64C 39/02; B64D 1/04

(52) U.S. Cl. CPC B64C 39/024; B64D 1/04; B64C 2201/02; B64C 2201/046; B64C 2201/22; B64C 2201/121; B64C 2201/123; B64C 2201/206; B64C 2201/082

(57) ABSTRACT

An unmanned aerial combat vehicle system is disclosed. The system provides for an unmanned aerial combat vehicle that is capable of performing reconnaissance, disrupting enemy communications, or delivering a weaponized payload. The unmanned aerial combat vehicle may also be equipped with a cloaking mechanism, where it can mask it's heat signature, or simulate an image on its outer surface.

### CLAIM OF PRIORITY

This application claims priority of the U.S. provisional patent application No. 62/219,239 filed on Sep. 16, 2015, the contents of which are fully incorporated herein by reference.

### FIELD OF THE EMBODIMENTS

The invention and its embodiments relate to an unmanned aerial vehicle (“drone”), in particular a stealth drone that has been optimized for disabling enemy communications.

### BACKGROUND OF THE EMBODIMENTS

Death has been an unavoidable consequence of nations attempting to get an upper hand over each other. Whether it is through war, espionage, or other acts of aggression between nation-states, human lives have been lost as long as these activities have gone on. However, with the development of the microprocessor and its related technologies, machines are capable of performing more and more of these unsavory tasks.

Chief among these machines is the unmanned aerial vehicle (“UAV”). These vehicles are either fixed-wing aircraft or rotorcraft that is capable of being operated from a remote location. Frequently, these vehicles lack the capability of housing a human pilot. This provides a number of benefits, such as increased fuel efficiency, maximum range, maneuverability, and flexibility in design. These UAV's are commonly used for surveillance, military operations, or for recreational use. In all three of these applications, the UAV is equipped with surveillance equipment, be it a standard camera, wide-angled video recorder, or some military-grade observation technologies.

Further, many of these UAV's are used for combat operations. In fact, there are so many UAV's optimized for combat that it quickly becomes prudent to distinguish between standard UAV's and unmanned combat aerial vehicles (UCAV). These UCAVs are used in a number of applications, such as delivering weaponized payloads, performing reconnaissance, and disrupting communications.

The last of these categories is of particular interest, as humanity grows increasingly reliant on wireless communications. However, as this reliance increases, as do the security measures surrounding these transmissions. As such, there exists a need for a UCAV that is capable of covertly disabling communications.

### REVIEW OF RELATED TECHNOLOGY

U.S. Patent Publication No.: 2014/0217230 pertains to a drone cargo helicopter having an elongated body. The elongated body has a low profile and has a front portion, a rear portion, an upper surface, a lower surface and a pair of opposing sides extending between the front and the rear portions. At least a first blade set is coupled to the upper surface and rotating in a first direction. Two or more struts are pivotally coupled to opposing sides or lower surface of the elongated body, the struts being coupled via a joint at a top end of the strut. The lower surface of the elongated body comprises a substantially planar surface between the front and rear portions, the substantially planar surface having one or more attachments to provide a rigid engagement with a container. The struts are pivotally movable between a first position and a second position, wherein in the first position, the struts support the elongated body a distance from a ground surface that is greater than a height of the container.

Canadian Patent Publication No.: 2699339 pertains to a site-specific photographic camouflage arrangement and method for making the same are provided. The site-specific photographic camouflage arrangement includes a digital photographic image and distorting disruptive patterns placed on the digital photographic image to create visual confusion to disguise the recognizable form of a camouflaged object by breaking up its outline.

Chinese Patent Publication No.: 103438721 pertains to a space-based orbital-transfer drone adopts a space station in the space as a base, and is based on the space communication technology, the detection technology and the automatic control technology. Through small-size, high-sound-speed, large-momentum and accurate attacks, the space-based orbital-transfer drone is a weapon system capable of realizing various combat missions. The space-based orbital-transfer drone has the advantages of being low in cost, high in efficiency, capable of being used many times, and capable of effectively amplifying the space combat ability under the condition of the current technology.

Chinese Patent No.: 201903295 pertains to an anti-terrorist shooting-head target drone comprising a target plate, a target bar, a target rotation driving mechanism, a single-chip computer, a wireless remote controller and a power supply, wherein the target plate is fixed at the upper end of the target bar; the lower end of the target bar is fixedly connected with an output rotating shaft of the target rotation driving mechanism; the rotation driving mechanism comprises a driving motor, a transmission mechanism and a motor control driving circuit; and a receiver of the wireless controller is connected with the motor control driving circuit. The anti-terrorist shooting-head target drone can solve the technical problem as follows: the traditional target drone cannot meet the requirements of modern multiform trainings on the versatile actual-combat environment: distance, direction, position, appearing-disappearing time, and the like of a simulated shot target.

U.S. Pat. No. 5,521,817 pertains to a method and apparatus for remotely controlling a formation of drones. A single drone is chosen as a formation leader. Each other drone in the formation has one other drone in the formation as its leader. A follower drone will sense relative movement parameters as well as inquire of its leader drone as to its other movement parameters. The follower drone will then control itself to follow the movements of its leader.

U.S. Pat. No. 6,868,314 pertains to a system for retrieving data from remote difficult to reach terrain, such as wilderness areas, etc. and in particular to a system comprised of one or more surface based data collectors in communication with one or more wireless transceivers adapted to transmit the collected data to an unmanned aerial vehicle adapted to fly within a predetermined distance from the data collector and receive data collected therefrom. The present invention further relates to an unmanned aerial vehicle adapted to fly a flight pattern relative to a moveable surface object or for controlling the position of a moveable surface object relative to the flight path of the unmanned aerial vehicle. Finally, the present invention relates to an improved unmanned aerial vehicle having airframe structural elements with electrical circuits adhered to the surfaces of the structural elements.

U.S. Pat. No. 8,874,283 pertains to a drone for inspection and a method of use are depicted wherein the drone is utilized in an enclosed space and is capable of being controlled with or without line of sight to the aircraft. The drone may land on generally horizontal or vertical surfaces. A method of use is taught as well.

U.S. Pat. No. 8,989,922 pertains to a drone. The drone may include: a navigation unit configured to determine the location of the drone and navigate the drone to designated locations; a radio frequency identification (RFID) reader configured to read RFID tag information from RFID tags; and a wireless network transceiver configured to periodically transmit the location of the drone and RFID tag information to an inventory management system. Various exemplary embodiments relate to a method performed by a drone. The method may include: receiving navigation path information; navigating the drone along the navigation path based on satellite location signals; determining current position information based on the satellite location signals; reading RFID tag information from a first RFID tag; and transmitting the RFID tag information and the current position information via a wireless client to a central computing system.

U.S. Patent Publication No.: 2011/0208373 pertains to a system for the control of at least one unmanned aerial vehicle from at least one aircraft, preferably a helicopter. The system comprises at least one computer system, at least one satellite communication system online with a satellite and at least one radio set for bidirectional data transfer between the aircraft and the at least one unmanned aerial vehicle.

U.S. Patent Publication No.: 2012/0061508 pertains to an armed drone system, notably equipped with a firing device and a steerable optronics ball comprising means of illuminating targets. The invention proposes that the firing device be oriented towards the rear, so as to reduce the problems of masking of the optronics ball by elements located in its line of sight, such as a front wheel for example. Moreover, because of operational use involving a phase for firing weapons and illuminating the target from the back, the armed drone moving away from the target, the vulnerability of the drone is lessened

U.S. Patent Publication No.: 2013/0206915 pertains to a vertical take-off and landing gyropendular craft or drone device able to move around in the following different physical environments: in the air, on land, at sea, underwater or in outer space, comprising upper and lower propulsion units, equipped with an annular fairing accommodating a certain number of electronically slaved wing or gas-powered drive or propulsion units situated in the continuation of the axis of this device, mounted on 3-D ball-joints at the ends of a certain number of telescopic rods, for example set at 120° apart at the periphery of the platform and orientable about the three axis according to the plane of flight of the multimodal multi-environment craft, a vertebral structure by way of a 3-D articulated central body of solid or hollow cylindrical shape for forming a stabilized function of stabilizing, maintaining the position and heading, and of an inertial rotary disc platform equipped underneath with a cabin of hemispherical shape extending from the vertebral structure, accommodating a payload or a useful application, designed for various fields of application i.e. the sector of defence or civil security, so as to perform functions of search and rescue, exploration, navigation, transport, surveillance and telecommunications infrastructure deployment in free space.

Various devices are known in the art. However, their structure and means of operation are substantially different from the present invention. Such devices fail to provide a device that is optimized for non-infant children, fail to enhance the child's imagination, which is capable of being used as a nap retraining device. At least one embodiment of this invention is presented in the drawings below, and will be described in more detail herein.

### SUMMARY OF THE EMBODIMENTS

The present invention provides for an unmanned aerial vehicle system, comprising: a vehicle, comprising: a wireless transceiver, an airframe, a propulsion system, a navigation mechanism, a processor, a memory, a power source; a control system, comprising: a wireless transceiver, an input device, capable of receiving a user's input and converting said user's input to electrical signals, a processor, a memory, wherein said memory contains at least one computer program executable by said processor, said at least one computer program being capable of interpreting said electrical signals and transmitting corresponding instructions to said propulsion system via said wireless transceiver, a power supply, wherein said control system is in wireless communication with said vehicle such that said control system is capable of utilizing said propulsion system of said vehicle in substantially real-time. Preferably, the airframe of the present invention comprises fixed wings. In some embodiments, the propulsion system comprises at least one rocket or jet engine, and preferably the at least one rocket or jet engine can be complimentarily reoriented to direct the motion of said vehicle. This may be achieved by at least one motor actuating at least one arm, connected to said propulsion system.

The present invention contemplates a number of different camouflage techniques. For example, the vehicle may be wrapped in a cloaking mechanism. Preferably, this cloaking mechanism simulates the appearance of outer space, but other environments. In other embodiments, this cloaking mechanism blends the external temperature of the vehicle with an area immediately surrounding the vehicle. While in many embodiments, the present invention is used purely for reconnaissance or for interrupting enemy communications, there exist many embodiments where the present invention is weaponized, and carries a weaponized payload.

However, in other embodiments, the present invention is equipped with at least one sensor, independently selected from the group consisting of electro-optical/infrared sensors, hyperspectral imaging sensors, LIDAR, DIAL, SAR, video recorders, and cameras. In addition to these sensors, the present invention may be equipped with a radio frequency jamming mechanism, or may broadcast strong signals at a predetermined frequency to act as an alternative jamming mechanism. Alternatively, the present invention may broadcast a signal at a predetermined frequency range and will lower the signal-to-noise ratio within said predetermined frequency range.

The present invention may be powered by an internal power source, an array of solar panels, or some combination thereof. As the vehicle of the present invention is unmanned, the control system for this vehicle may be located in an automobile, or some sort of waystation.

The present invention also contemplates a method of disrupting satellite communications comprising: deploying, from the stratosphere, a vehicle, comprising: a wireless transceiver, an airframe, a propulsion system, a navigation mechanism, a processor, a memory, a power source, a cloaking mechanism, and a payload; operating, said vehicle via a control station, comprising: a power source, a memory, a processor, and a control mechanism, guiding, said vehicle into the thermosphere; transmitting, via said wireless transceiver of said vehicle, a transmission within a predetermined radio frequency range for a pre-determined amount of time. Preferably, in this step of operating, the vehicle, via a control station, is performed by a human operator.

It is an object of the present invention to provide a system that is capable of interrupting enemy communications.

It is an object of the present invention to provide a system that is capable of disabling a satellite.

It is an object of the present invention to provide an unmanned aerial vehicle suitable for combat situations.

It is an object of the present invention to provide a means to operate an unmanned aerial vehicle remotely.

It is an object of the present invention to provide an unmanned aerial vehicle capable of blending into its surroundings.

It is an object of the present invention to provide an unmanned aerial vehicle that cannot be detected by a machine.

### BRIEF DESCRIPTION OF THE DRAWINGS

FIG. 1 shows a top perspective view of an embodiment of the present invention in a fully-retracted position.

FIG. 2 shows a bottom perspective view of an embodiment of the present invention is a fully-extended position.

FIG. 3 shows a top view of an embodiment of the present invention, illustrating the rotatable nature of the at least one source of propulsion.

FIG. 4 shows a top view of an embodiment of the present invention, illustrating the camouflage function of the present invention.

FIG. 5 shows a cross-sectional view of an embodiment of the present invention.

FIG. 6 shows a perspective view of a transportation rocket housing an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

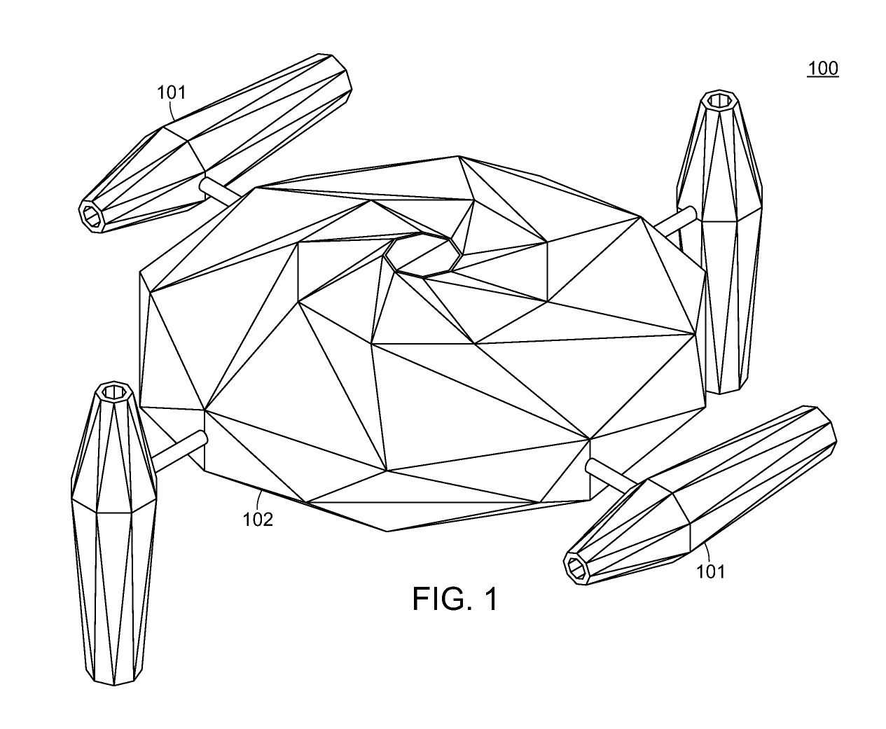

FIG. 1 shows a top perspective view of an embodiment of the present invention in a fully-retracted position. Here, vehicle 100 is equipped with propulsion system 101, and airframe 102. While airframe 102 resembles an octagon here, because vehicle 100 is intended to operate in the earth's atmosphere, the principles of aerodynamics need not be adhered to due to the low density of the air that exists in the stratosphere. Further, there are many suitable mechanisms that can power propulsion system 101, such as, but not limited to, ramjet, rocket propulsion, afterburners, propellers, turbines, and fans. Many modern commercial aircraft prioritize high engine efficiency and low fuel usage, while military aircraft focus on having excess thrust so that they can achieve high acceleration and help overcome the drag that occurs at high-speeds. As such, in many preferred embodiments of the present invention, propulsion system 101 will be capable of creating large amounts of thrust very quickly, despite the fact that less drag will occur at the present invention's optimized operating altitude.

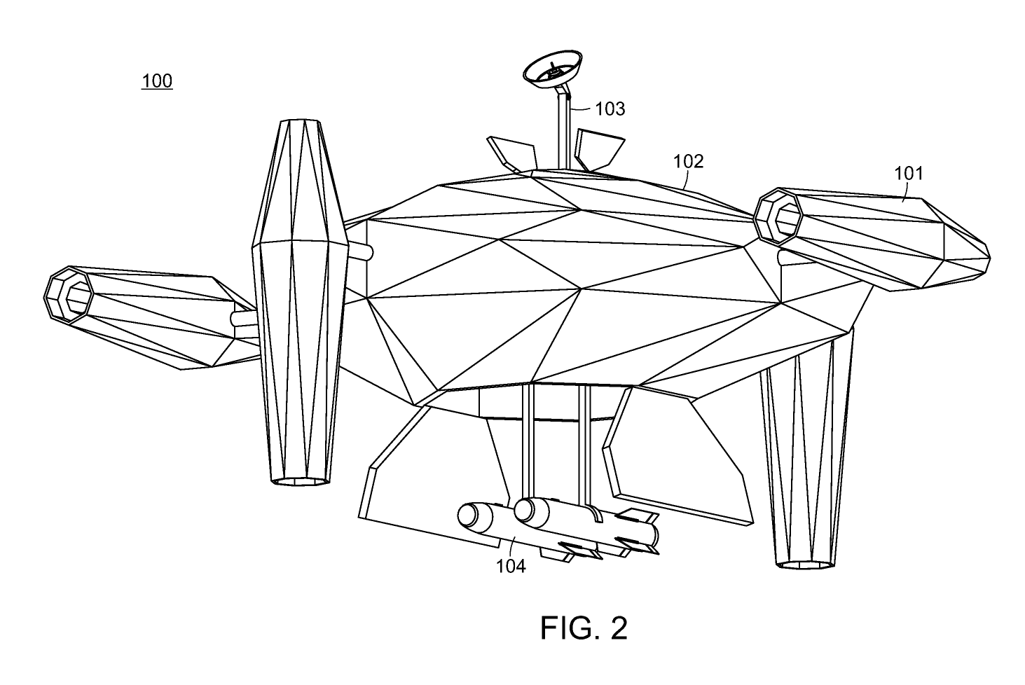

Referring to FIG. 2, another perspective view of an embodiment of the present invention is provided, where the vehicle's payload and wireless transceiver are fully extended. Here, vehicle 100 has airframe 102, propulsion system 101, payload 104, and wireless transceiver 103. In contrast to FIG. 1, both payload 104 and wireless transceiver 103 are in an extended position. This functionality is imperative to the use of the vehicle of the present invention. This is in part due to the cloaking mechanism that vehicle 100 is equipped with. AN additional benefit is that vehicle 100 may maneuver into the appropriate position before exposing itself to a potential enemy.

While payload 104 here is weaponized, not all embodiments of the present invention have a weaponized payload. For example, vehicle 100 may carry an array of sensors, such as but not limited to electro-optical/infrared sensors, hyperspectral imaging sensors, LIDAR, DIAL, SAR, video recorders, and cameras. When vehicle 100 is equipped with these sensors, it will be most suitable for use in reconnaissance missions. In those situations, wireless transceiver 103 may double as radio frequency jammer. This can be achieved by broadcasting a strong signal at the same frequency that an enemy is communicating on, or may be achieved by transmitting static, or some other predetermined sound across a wide range of frequencies.

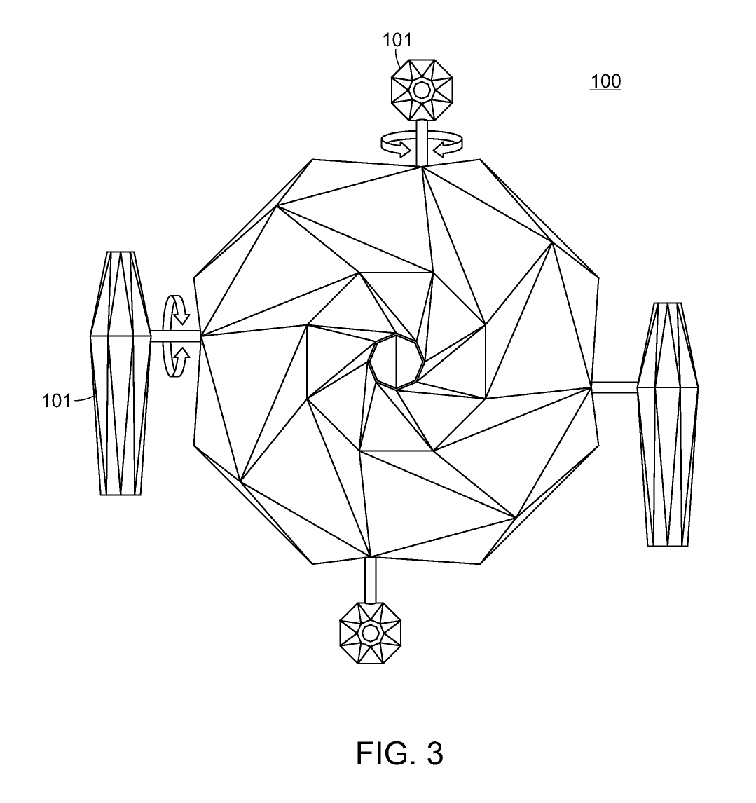

FIG. 3 shows a top view of an embodiment of the present invention, illustrating the rotatable nature of the at least one source of propulsion. The rotatable nature of propulsion system 101 allows vehicle 100 to navigate freely in 3-dimensional space. In a preferred embodiment, propulsion system 101 is comprised of 4 rocket-powered engines, however, embodiments with two or more engines are also contemplated by the present invention. In the depicted embodiment, vehicle 100 will use the on-board processor and memory, coupled with an integrated GPS system to move vehicle 100 through Cartesian space. By adjusting the thrust and angle of propulsion system 101 in a complementary fashion, vehicle 100 will be able to move freely across any Cartesian axis. This provides for an incredibly high level of maneuverability, which is in part made possible by the lower levels of gravity and air density that exist in the Earth's upper atmosphere.

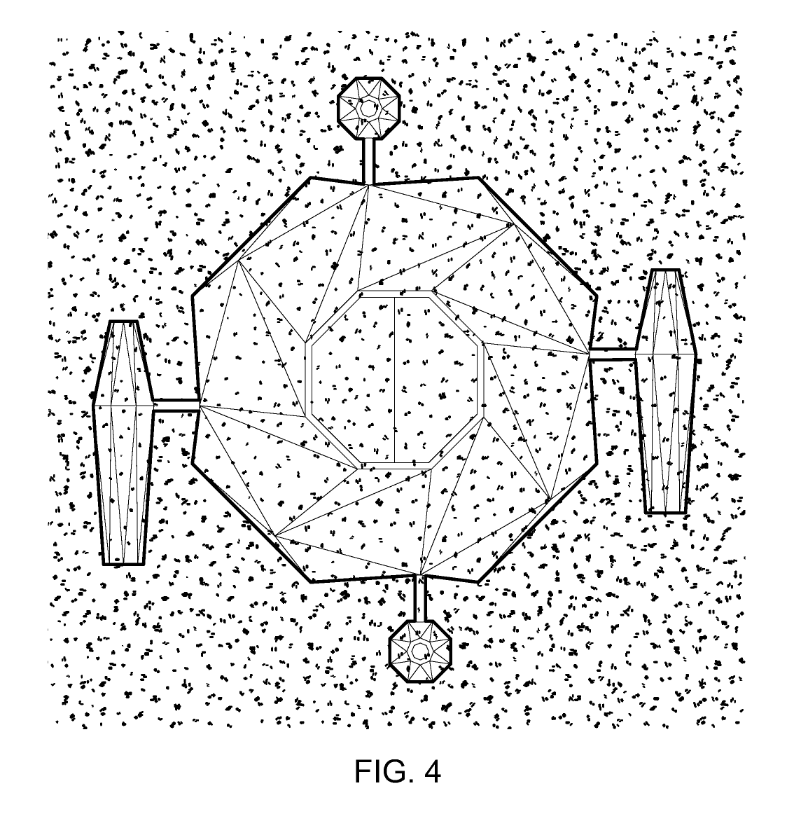

Referring to FIG. 4, a top view of an embodiment of the present invention, illustrating the camouflage function of the present invention. Here, the present invention is simulating a night sky, although in various embodiments, the present invention will be able to simulate a number of different images and textures. Preferably, the present invention will be equipped with at least one camera such that the camera will capture an image and the opposite side of the vehicle of the present invention will be able to reproduce that image.

Further, in a preferred embodiment of the present invention, ADAPTIV cloaking technology will be employed. That is, the present invention will be able to mimic the heat signature of another type of vehicle, or eliminate its heat signature entirely.

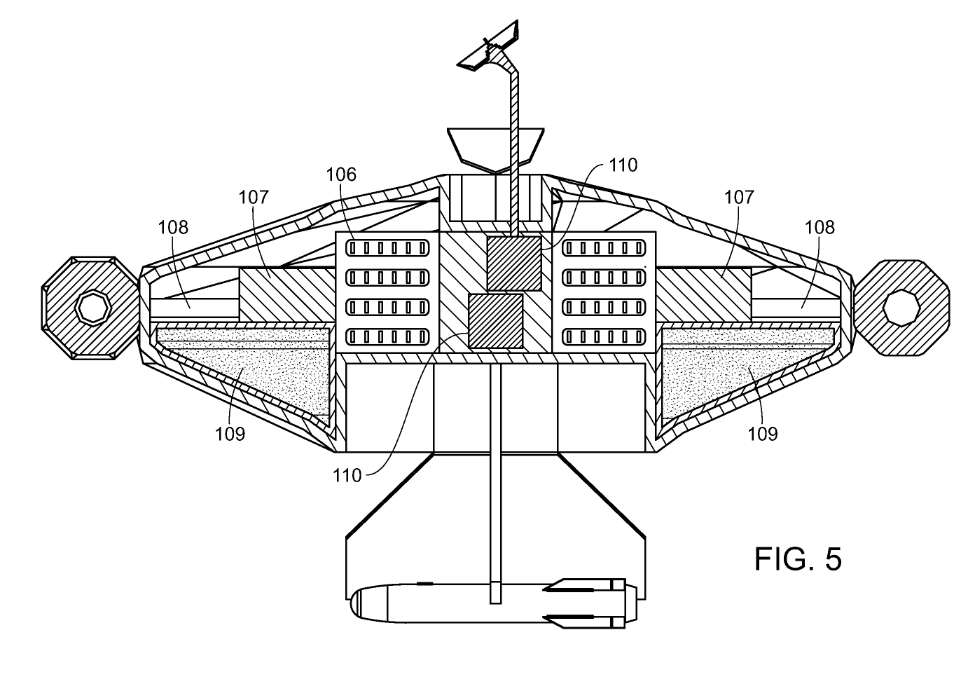

FIG. 5 shows a cross-sectional view of an embodiment of the present invention. Here, the vehicle of the present invention is equipped with server 106, at least one motor 107, at least one fuel tank 109, and retracting motor 110. As can be seen, at least one motor and at least one arm work in conjunction to manipulate propulsion system 101 (See FIG. 1). At least one motor 107 is capable of rotating at least one arm 108, such that the various components of propulsion system 101 may move in a way that enables the present invention to operate. In one embodiment, at least one motor 107 is also capable of extending arm 108 in addition to rotating it. This embodiment also features retracting motor 110. Here, the present invention is equipped with two retracting motors 110; one for the payload, and one for the wireless transceiver. This functionality allows the cloaking mechanism of the present invention to envelop the entirety of the UCAV. Further, the outer shell of the UCAV is armored, while the internal components, which are revealed when retracting motors 110 are extended, thus exposing the present invention.

Server 106 is comprised of at least one memory and at least one processor, and handles the computational processing of the UCAV. At least one fuel tank 109 typically holds rocket fuel, but is capable of storing any fluid that is suitable for use with the propulsion system of the present invention.

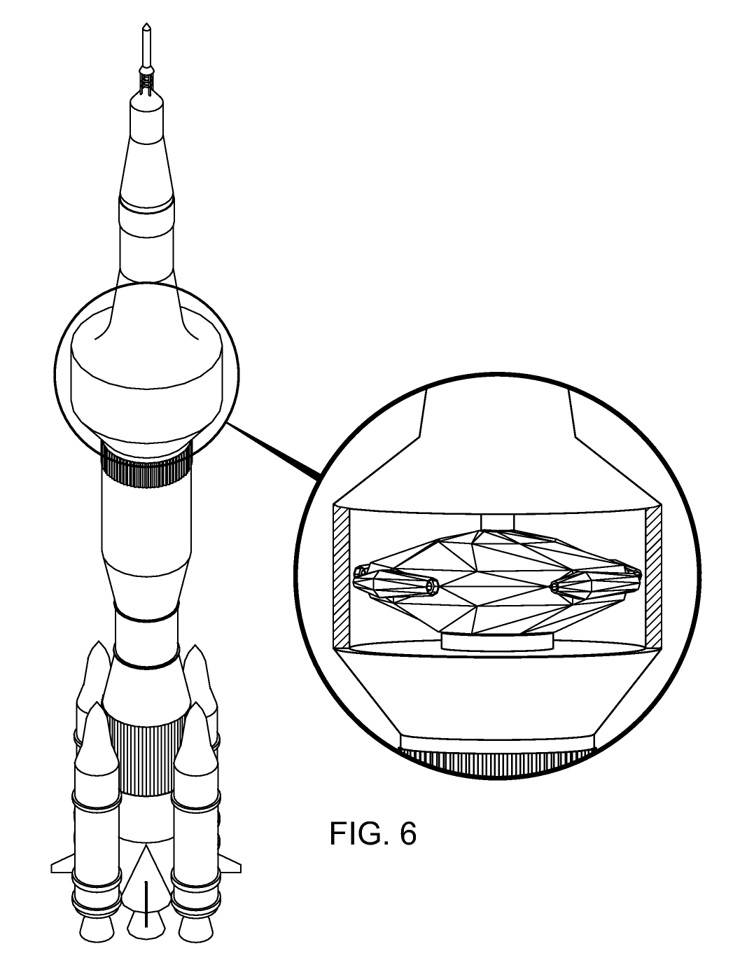

FIG. 6 shows a perspective view of a transportation rocket housing an embodiment of the present invention. In alternative embodiments, the UCAV of the present invention can be “ferried” to an altitude of 50,000 ft and can use its propulsion system to ascend into the earth's atmosphere. In yet another embodiment, the present invention is capable of taking off from ground-level.

The UCAV of the present invention is intended to be operated remotely. The control station can be in an automobile, in a building on earth, or from an aircraft near the UCAV.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Therefore, it is intended that the disclosure not be limited to the particular embodiments disclosed.

1. An unmanned aerial vehicle system, comprising:
an unmanned vehicle, comprising:
a wireless transceiver,
an airframe,
a propulsion system,
a navigation mechanism,
a processor,
a memory,
a power source,
at least one fuel tank;
a control system, comprising:
a wireless transceiver,
an input device, capable of receiving a user's input and converting said user's input to electrical signals,
a processor,
a memory,
wherein said memory contains at least one computer program executable by said processor,
said at least one computer program being capable of interpreting said electrical signals and transmitting corresponding instructions to said propulsion system via said wireless transceiver,
a power supply,
wherein said control system is in wireless communication with said vehicle such that said control system is capable of utilizing said propulsion system of said vehicle in substantially real-time.

2. The unmanned aerial vehicle system of claim 1, further comprising a payload delivery system, wherein said control system is capable of operating said payload delivery system.

3. The unmanned aerial vehicle system of claim 1, wherein said airframe comprises fixed wings.

4. The unmanned aerial vehicle system of claim 1, wherein said propulsion system comprises at least one rocket or jet engine.

5. The unmanned aerial vehicle system of claim 4, wherein said at least one rocket or jet engine can be complimentarily reoriented to direct the motion of said vehicle,
wherein said reorientation is performed via at least one motor rotating at least one arm.

6. The unmanned aerial vehicle system of claim 1, where said vehicle is wrapped in a cloaking mechanism.

7. The unmanned aerial vehicle system of claim 6, wherein said cloaking mechanism projects the appearance of outer space.

8. The unmanned aerial vehicle system of claim 6, wherein said cloaking mechanism blends the external temperature of the vehicle with an area immediately surrounding the vehicle.

9. The unmanned aerial vehicle system of claim 2, wherein said payload is a weapon.

10. The unmanned aerial vehicle system of claim 2, wherein said payload is at least one sensor selected from the group consisting of: electro-optical/infrared sensors, hyperspectral imaging sensors, LIDAR, DIAL, SAR, video recorders, and cameras.

11. The unmanned aerial vehicle system of claim 1, wherein said power source utilizes power obtained by at least one solar panel disposed on said vehicle.

12. The unmanned aerial vehicle system of claim 1, wherein said control system is housed in an automobile.

13. The unmanned aerial vehicle system of claim 1, wherein said vehicle further comprises a radio frequency jamming mechanism.

14. The unmanned aerial vehicle system of claim 1, wherein said vehicle is capable of transmitting a signal within a predetermined frequency range.

15. The unmanned aerial vehicle system of claim 1, wherein said vehicle lowers the signal-to-noise ratio within said predetermined frequency range.

16. The unmanned aerial vehicle system of claim 1, wherein said vehicle further comprises at least one weapon.

17. The unmanned aerial vehicle system of claim 1, wherein said wireless transceiver is retractable into said airframe.

18. The unmanned aerial vehicle system of claim 2, wherein said payload is retractable into said airframe.

19. The unmanned aerial vehicle system of claim 2, wherein said control system is capable on controlling the retracting of said payload, as well as the operation of said payload.

20. A method of disrupting satellite communications comprising:
deploying, from the stratosphere, an unmanned vehicle, comprising:
a wireless transceiver,
an airframe,
a propulsion system,
a navigation mechanism,
a processor,
a memory,
a power source,
a cloaking mechanism, and
a payload
at least one fuel tank;
operating, said vehicle via a control station, comprising:
a wireless transceiver,
an input device, capable of receiving a user's input and converting said user's input to electrical signals,
a processor,
a memory,
wherein said memory contains at least one computer program executable by said processor,
said at least one computer program being capable of interpreting said electrical signals and transmitting corresponding instructions to said propulsion system via said wireless transceiver,
a power supply,
wherein said control system is in wireless communication with said vehicle such that said control system is capable of utilizing said propulsion system of said vehicle in substantially real-time
guiding, said vehicle into the thermosphere;
transmitting, via said wireless transceiver of said vehicle, a transmission within a predetermined radio frequency range for a pre-determined amount of time.

21. The method of claim 20, wherein the step of operating, said vehicle via a control station is performed by a human operator.

22. The method of claim 20, wherein said payload is retractable into said airframe.

23. The method of claim 22, wherein said control system is capable on controlling the retracting of said payload, as well as the operation of said payload.
